(19) United States
(12) Patent Application Publication
(10) Pub. No.: US 2007/0052708 A1
(43) Pub. Date: Mar. 8, 2007

(54) Method of performing a panoramic demonstration of liquid crystal panel image simulation in view of observer's viewing angle

(76) Inventors: Tae Young Won, Kyeonggi-do (KR); Suk in Yoon, Incheon (KR)

Correspondence Address: MARTINE PENILLA & GENCARELLA, LLP, 710 LAKEWAY DRIVE, SUITE 200, SUNNYVALE, CA, 94085, US

(21) Appl. No.: 10/552,669

(22) PCT Filed: May 19, 2004
(86) PCT No.: PCT/KR04/01182

§ 371 Date: Oct. 13, 2006

(30) Foreign Application Priority Data
Feb. 7, 2004 (KR) 10-2004-0008122

(51) Int. Cl. G06T 15/20

(52) U.S. Cl. 345/427

(57) ABSTRACT

The present invention discloses a method for displaying the result of the image simulation predicting color tone, contrast and brightness of image shown as a viewing angle of observer. The invention includes steps that perform transformation of coordinates on the basis of a viewing angle of observer and projection of image generating new image in perspective. As a result, the result of the image simulation can be shown and analyzable with reality. Moreover, the invention affords convenience in the analysis of the result of image simulation.

### FIELD OF THE INVENTION

The present invention relates to a method for performing a liquid crystal panel image simulation capable of predicting color, brightness, and contrast characteristics of an output image in view of a viewing angle of an observer who views a liquid crystal panel, and displaying the result of the image simulation.

More particularly, the present invention relates to a method for performing an image simulation in view of a viewing angle, and displaying the result of the image simulation.

With the increasing development of multimedia technologies, more people are using a liquid crystal displays (LCDs) which can be made small in size and light in weight such that they are applicable to notebook computers, personal digital assistants (PDAs), and hand-held phones, etc. However, the LCDs have different color implementation characteristics according to viewing angles, such that they have a disadvantage in that a single image is differently viewed by a user's eye according to viewing angles. In order to solve the above-mentioned problem, many developers have conducted intensive research into a method for improving image output characteristics varying with a viewing angle.

In order to improve the image output characteristics varying with the viewing angle of the LCD, there have been widely used a variety of simulation software programs which calculate electric/optical characteristics of the LCD using a numerical analysis method, and predict a final output image of the LCD on the basis of the calculated result.

FIG. 1 is a conceptual diagram illustrating an image output method implemented by conventional LCD simulation software. Referring to FIG. 1, the conventional LCD display simulation software 10 acquires simulation result images 31 and 32 associated with individual viewing angles of an input image 20, and displays the acquired simulation result images 31 and 32 using an image result output module.

In the meantime, an LCD image viewed with the naked eye of a user is determined to be an image based on a new coordinate system (i.e., an eye coordinate system) on the basis of an eye position (i.e., a view point) of an observer who views an object, instead of an image based on a three-dimensional world coordinate system including x, y, and z axes. Moreover, there is no change in coordinate information contained in a world coordinate system associated with a screen, but the other coordinate information on the eye coordinate system varies with an observer's viewing angle. Therefore, although the LCD is fixed to a single position, the observer views different images according to the direction of his or her viewing angle.

Therefore, when the user views a simulation result image, the above-mentioned conventional image output method does not consider variation in shape according to the observer's viewing angle, and displays only an image formed by LCD image implementation characteristics varying with the variation in viewing angle.

FIG. 2 shows a difference between an image of the conventional image output scheme and the other image in which an eye-coordinate variation caused by the viewing angle is considered. Referring to FIG. 2, if the observer views the LCD at a viewing angle (0,45), an LCD image viewed with the naked eye of the observer is determined to be an upper image 41 in which perspective is considered. However, the conventional image output scheme has a disadvantage in that it displays only an image formed by LCD image implementation characteristics in which a perspective variation based on the observer's viewing angle is not considered as shown in a lower image 42. The observer must view a current image after recognizing numerical viewing angle information of the current image, resulting in greater inconvenience of use.

In the case where the observer views simulation images based on viewing angles of not only the LCD but also other displays which must analyze viewing angle characteristics, the above-mentioned problems commonly occur in the above-mentioned LCD and other displays.

### SUMMARY OF THE INVENTION

Accordingly, it is an object of the present invention to provide a method for performing an image simulation according to an observer's viewing angle, and providing the result of the image simulation in which the viewing angle information of the observer is considered.

It is another object of the present invention to provide a method for outputting an image simulation result such that an observer can conveniently analyze image implementation characteristics varying with a viewing angle of to the observer.

In accordance with the present invention, the above and other objects can be accomplished by the provision of a method for displaying an image simulation result comprising the steps of: a) receiving information associated with a viewing angle of an observer; b) generating viewing transformation information using the viewing angle information; c) reading simulation image data to be displayed on a screen on the basis of the viewing angle; and d) projecting the read image on a projection plane perpendicular to the viewing angle, and performing a mapping process of the image on the projection plane.

### BRIEF DESCRIPTION OF THE DRAWINGS

Further feature of the present invention will become apparent from a description of a method for performing a panoramic demonstration of a liquid crystal panel image simulation according to observer's viewing angle taken in conjunction with the accompanying drawings of the preferred embodiment of the invention, which, however, should not be taken to be limitative to the invention, but are for explanation and understanding only.

In the drawing:

FIG. 1 is a conceptual diagram illustrating an image output scheme for providing an LCD image simulation result according to the conventional art;

FIG. 2 shows a difference between an image formed by a conventional image output scheme and the other image in which an eye-coordinate variation caused by the direction of the observer's viewing angle is considered;

FIG. 3 is a flow chart illustrating a method for displaying an image simulation result according to the present invention;

FIG. 4 exemplarily shows viewing-angle direction information and viewing transformation information according to an observer's viewing angle according to the present invention;

FIG. 5 shows an example in which coordinate information on an eye coordinate system is projected on a projection plane according to the present invention;

FIGS. 6˜8 show methods for entering viewing angle information according to the present invention; and

FIG. 9 shows a plurality of mapping-image output examples according to the present invention.

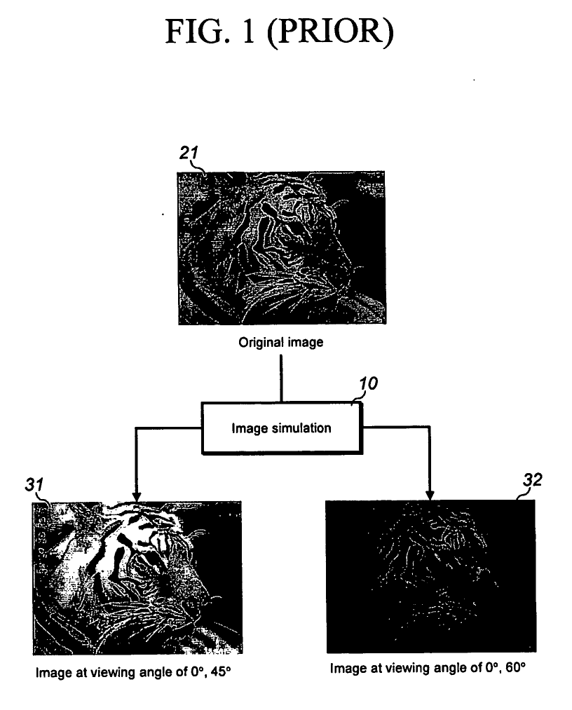

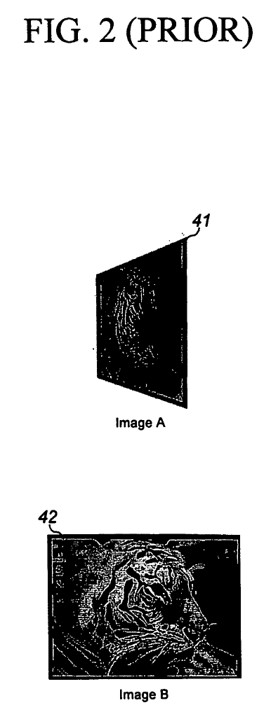

### DETAILED DESCRIPTION OF THE PREFERRED EMBODIMENT OF THE INVENTION

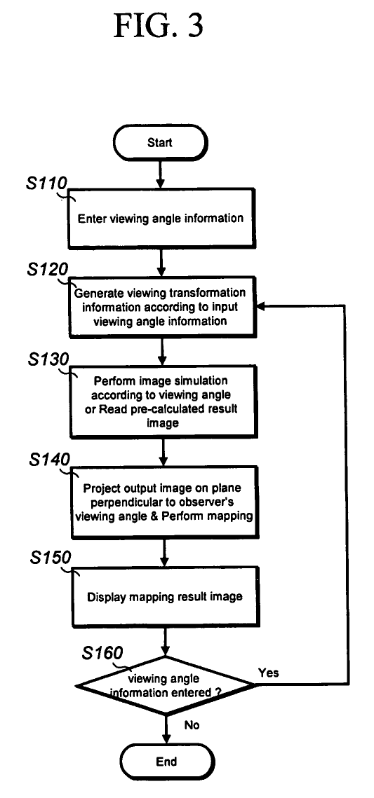

A method for outputting an image simulation result according to the present invention will be explained in detail with reference to FIGS. 3˜9.

FIG. 3 is a flow chart illustrating a method for displaying an image simulation result according to the present invention. Referring to FIG. 3, a method for displaying an image simulation result according to the present invention receives information of a viewing angle desired by an observer at step S110, generates viewing transformation information associated with the received viewing angle using the received viewing angle information at step S120. Subsequently, the above-mentioned method performs image calculation corresponding to a viewing angle of the observer or reads pre-calculated image data at step S130. An image to be displayed is projected on a plane perpendicular to the observer's viewing angle, and is mapped to the plane at step S140. And, the mapped image is displayed at step S150. It is determined whether the observer enters an input signal associated with another viewing-angle direction at step S160. If the observer enters another viewing angle information, a plurality of steps from step S110 in which viewing transformation information associated with the entered viewing angle information is generated, to step S160 in which it is determined whether yet another viewing angle information is entered, are repeated.

In accordance with a preferred embodiment of the present invention, step S120 during which viewing transformation information associated with a viewing angle upon receiving viewing angle information is generated, step S140 during which a calculated image to be displayed on a screen is projected on and is mapped to a plane perpendicular to the observer's viewing angle in light of an observer's viewing angle, and step S150 during which the mapped image is displayed may use functions provided from open-source graphics libraries such as OpenGL and MESA, etc.

Viewing-angle information or viewing-angle direction information according to the present invention is indicative of a view-point coordinate for use in one or more world coordinate systems. Also, the viewing transformation information is indicative of information for converting a coordinate for use in a world coordinate system into a coordinate for use in an eye coordinate system.

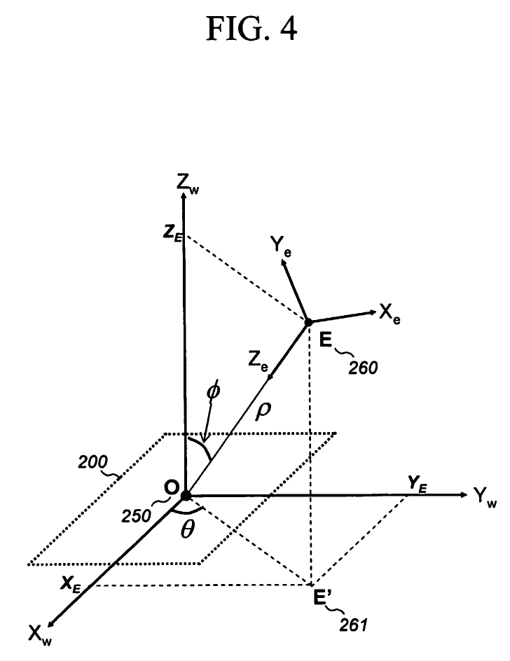

FIG. 4 exemplarily shows viewing-angle direction information and viewing transformation information according to an observer's viewing angle according to the present invention. Referring to FIG. 4, the LCD screen 200 is positioned on a XwYw plane contained in a world coordinate system including Xw,Yw, and Zw axes. An origin (0, 250) of the world coordinate system is positioned at the center of the LCD. In this case, the viewing-angle information is indicative of a spherical coordinate (ρ, θ, φ) or a rectangular coordinate (X_{E}, Y_{E}, Z_{E}) in association with a view point (E, 260) displayed on the world coordinate system. In the spherical coordinate, ρ is indicative of a distance from the origin 0(250) of the world coordinate system to a view point E(260), θ is indicative of an angle formed between the Xw axis and a segment passing through a point E′(260) projected on the XwYw plane and the origin 0(250), and φ is indicative of an angle formed between the Zw axis and a vector from the origin 0(250) to the view point E(260).

In the meantime, the eye coordinate system includes Xe,Ye, and Ze axes, and uses the view point E(260) as the origin. Also, the Ze axis is arranged in parallel to a vector from the view point E(260) to the origin (0) of the world coordinate system, and the XeYe plane is arranged in perpendicular to the Ze axis.

In this case, a predetermined point (X_{E}, Y_{E}, Z_{E}) on the world coordinate system is converted into a point (xₑ, yₑ, zₑ) by a viewing-transformation matrix shown in the following equation 1. The viewing-transformation information may be indicative of individual components of the viewing-transformation matrix.

$$[ \begin{matrix}{x}_{e} \\ {y}_{e} \\ {z}_{e} \\ 1\end{matrix} ] = [ \begin{matrix}- sin θ & - cos ϕ sin θ & - sin ϕ cos θ & 0 \\ cos θ & - cos ϕ sin ϕ & - sin ϕ sin θ & 0 \\ 0 & sin ϕ & cos ϕ & 0 \\ 0 & 0 & ρ & 1\end{matrix} ] [ \begin{matrix}{x}_{E} \\ {y}_{E} \\ {z}_{E} \\ 1\end{matrix} ] \qquad [ Equation 1 ]$$

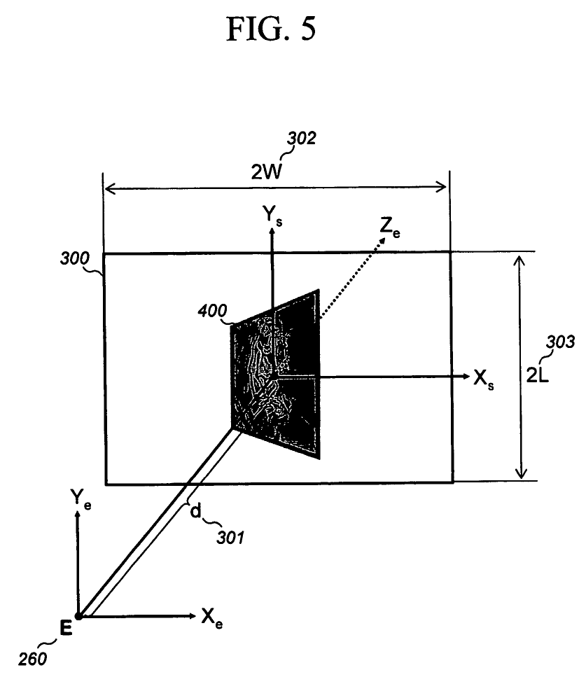

FIG. 5 shows an example in which coordinate information on an eye coordinate system is projected on a projection plane according to the present invention. Referring to FIG. 5, provided that a projection plane 300 is spaced apart from the view point E(260) by a vertical distance d(301), a horizontal width 302 of the projection plane is determined to be a value of 2W, and a vertical width 303 of the projection plane is determined to be a value of 2L, a coordinate on the eye coordinate system is determined to be coordinate information (X,Y) on the XsYs projection plane including Xs and Ys axes, and the coordinate information (X,Y) can be represented by the following equations 2 and 3:

$$\begin{matrix}X = d \frac{{x}_{e}}{{z}_{e}} + W & [ Equation 2 ] \\ Y = d \frac{{y}_{e}}{{z}_{e}} + L & [ Equation 3 ]\end{matrix}$$

Therefore, according to the present invention, an observer can allow an LCD image 400 varying with his or her viewing angle information to be displayed. In other words, image data differently calculated according to viewing angle information or pre-calculated image data is read out and is mapped to an LCD image in which perspective is considered, resulting in the implementation of a more realistic image varying with a viewing angle.

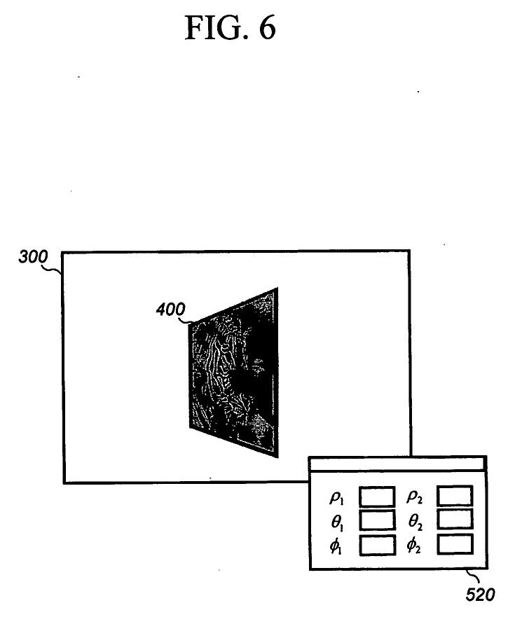

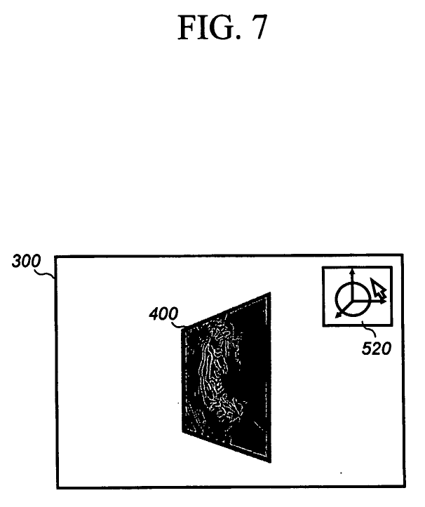

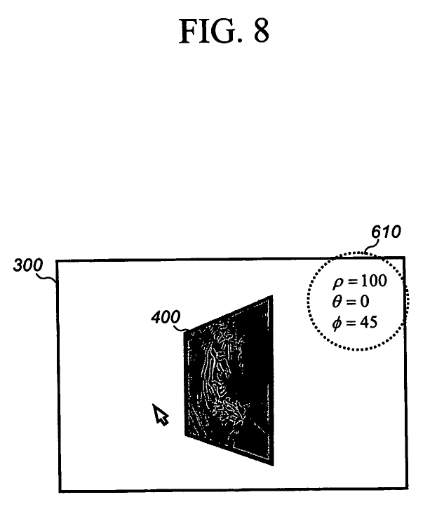

FIGS. 6˜8 show methods for entering viewing angle information according to the present invention. As shown in FIG. 6, a user enters a spherical coordinate or a rectangular coordinate in association with one or more view points using a dialogue box 510 implemented by Windows program, such that the user can enter or correct viewing angle information. The user can also select pre-defined viewing angle information instead of the desired viewing angle information. As shown in FIG. 7, the user may determine the position of the view point on an additional coordinate system 520 using a mouse or keyboard, and may enter or correct the position of the view point. As shown in FIG. 8, the user may click on or drag a desired coordinate on the projection plane 300 on which a mapped image is displayed, using a mouse, such that the user may enter or correct viewing angle information in real time, and at the same time may control the mapped image to be displayed.

In accordance with a preferred embodiment of the present invention, either one of information associated with an output image and viewing angle information 610 and their combination can be displayed on the projection plane 300 at the same time.

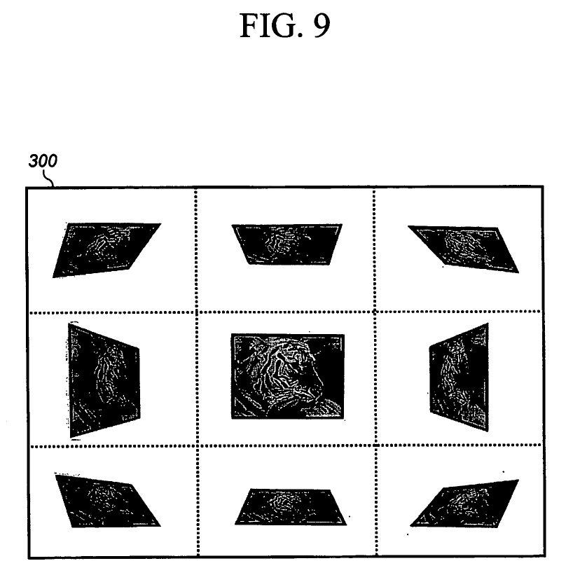

FIG. 9 shows a plurality of mapping-image output examples according to the present invention. Referring to FIG. 7, a plurality of divided projection planes are displayed at the same time, such that mapping result images associated with different viewing angles are shown at the same time.

As apparent from the above description, a method for displaying a simulation result image according to the present invention allows an image simulation result to be displayed in the form of an image viewed with the naked eye of an observer who views an LCD screen, such that it can analyze implementation characteristics of a more realistic image. Also, the present invention allows the observer to enter a variety of viewing angles, and provides the observer with a variety of resultant images, and allows the observer to conveniently analyze image characteristics varying with a viewing angle.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. A method for displaying panel image simulation result, which exhibits the electro optical characteristics of a liquid crystal display (LCD) panel as a function of a viewing angle of an observer who views the LCD panel, the method comprising the steps of:
a) converting the observer's viewing angle into a coordinate information;
b) performing a viewing transformation which converts a coordinate information in a world coordinate system into a coordinate information in an eye coordinate system on the basis of direction information of the observer's viewing angle;
c) reading out estimated image date from the memory to out of the viewing transformation results;
d) projecting a three-dimensional coordinate image for use in the eye coordinate system having been read at the step (c) on a projection plane perpendicular to the converted viewing angle, and mapping the projected result to a two-dimensional coordinate; and
e) displaying the mapping result image.

2. The method as set forth in claim 1, wherein the step (a) includes the step of:
receiving view point information of the observer when the observer clicks on a position of a view point using a mouse.

3. The method as set forth in claim 1, wherein the step (a) includes the step of:
correcting a position of a view point using a mouse-dragging operation or arrow keys of a keyboard, and receiving coordinate information of the view point.

4. The method as set forth in claim 1, wherein the step (b) includes the step of:
using functions contained in a graphics library such as OpenGL or MESA.

5. The method as set forth in claim 1, wherein the step (d) includes the step of:
using functions contained in a graphics library such as OpenGL or MESA.

6. The method as set forth in claim 1, wherein the step (e) includes the step of:
displaying a mapping result image on one or more divided projection planes.

7. The method as set forth in claim 1, wherein the step (e) includes the step of:
further including either one of original image information and viewing angle information or their combination, and displaying the mapping result image.

8. The method as set forth in claim 1, wherein the step (e) includes the step of:
using functions contained in a graphics library such as OpenGL or MESA.
